(19) United States
(12) Patent Application Publication
(10) Pub. No.: US 2003/0219512 A1
(43) Pub. Date: Nov. 27, 2003

(54) Bacterial extracellular polysaccharide, gluconacetobacter spp. strain producing it and their use in food or pet food products

(75) Inventors: Philippe Duboc, Lausanne (CH); Cornelia Boesch, Zuerich (CH); Christoph Cavadini, Le Mont-Pelerin (CH); Monica Fischer, Savigny (CH); Walter P. Hammes, Filderstadt (DE); Gerd Schueller, Stuttgart (DE); Francesca Stingele, Lausanne (CH); Sebastien Vincent, Pully (CH)

Correspondence Address: WINSTON & STRAWN, PATENT DEPARTMENT, 1400 L STREET, N.W., WASHINGTON, DC, 20005-3502, US

(73) Assignee: NESTEC S.A.

(21) Appl. No.: 10/424,870

(22) Filed: Apr. 29, 2003

Related U.S. Application Data
(63) Continuation of application No. PCT/EP01/12582, filed on Oct. 25, 2001.

(30) Foreign Application Priority Data
Nov. 2, 2000 (EP) 00203843.8

(51) Int. Cl. A23K 1/00

(52) U.S. Cl. 426/52

(57) ABSTRACT

The present invention relates to a novel non-cellulosic bacterial extracellular polysaccharide, produced from the Gluconacetobacter spp. strain, and methods of using the polysaccharide and strain in the preparation of various foods.

### CROSS REFERENCE TO RELATED APPLICATIONS

This application is a continuation of the U.S. National Stage designation of International Application PCT/EP01/12582, filed on Oct. 25, 2001, which is expressly incorporated herein by reference thereto.

### FIELD OF THE INVENTION

This invention relates generally to microbial extracellular polysaccharides used in the food industry, and more particularly to a novel non-cellulosic bacterial extracellular polysaccharide, the strain from which it is produced, and methods of isolating the polysaccharide, and the Gluconacetobacter spp. strain. The invention is also related to methods food compositions in which the polysaccharide and/or the strain are included.

### BACKGROUND OF THE INVENTION

Microbial extracellular polysaccharides are high-mass, long-chain polymers that are secreted into the environment by a variety of many bacteria. It is well known that microbial extracellular polysaccharides are used in the food industry as thickening, gelling, texturizing, suspending and encapsulating agents. (Griffin, A. M. et al., (1996b) FEMS Microbiol. Lett. 137: 115-121; Sutherland, I. W., and Tait, M. I. (1992) Bipolymers. In J. Lederberg (ed.), Encyclopedia of microbiology, Academic Press, Inc., San Diego, Calif.). Xanthan, for example, is currently one of the major texturizing agents used in the food industry. Although commonly used in food preparation, xanthan is produced by a non-food grade plant pathogen, namely, Xanthomaonas campestris.

It has been shown that Gluconacetobacter xylinus (formerly Acetobacter xylinum or Acetobacter xylinus) has the capacity to produce cellulose as well as cellulosic-based polysaccharides. For example, some strains of Gluconacetobacter xylinus have the capacity to produce the complex acidic extracellular polysaccharide “acetan.” Acetan consists of a cellulosic backbone to which a pentasaccharide branch is bound every two glucose residues. It has been determined that acetan contains glucose, mannose, glucuronic acid and rhamnose at a molar ratio of 4:1:1:1.

Other strains of Gluconacetobacter xylinus produce different polysaccharides. But even those polysaccharides are cellulosic-based polysaccharides. For Example, A. xylinus B42 secretes both cellulose and acetan (Petroni et al., (1996) Cell Mol Biol., 42(5):759-67); whereas a mutant of A. xylinus B42, CR¼, secretes a polysaccharide with a sidechain shorter than acetan (Colquhoun et al., (1995) Carbohydr Res., 269(2):319-31). It is also known that G. xylinus NCI 1005 secretes a β2→6-fructan (levan) when grown on sucrose (Tajima, K. et al., (1997) Macromol. Symp. 120, 19-28); and G. xylinus NCI 1005 secretes acetan when grown on glucose (Tayama, K. et al, (1986) Agric. Biol. Chem. 50 1271-1278). Thus, it has been widely understood that Gluconacetobacter xylinus has the capacity to produce cellulosic polysaccharides, such as acetan in addition to cellulose itself.

Accordingly, a need exist for a novel polysaccharide having favorable texturizing properties and that is produced by a food grade bacterium.

### SUMMARY OF THE INVENTION

It has surprisingly been found that strains of G. xylinus are capable of producing a non-cellulosic bacterial polysaccharides. Thus, in accordance with one aspect of the invention there is provided a novel bacterial polysaccharide comprising (a) a non-cellulosic backbone having 4-beta and 6-beta linkages; (b) at least one sidechain per repeating unit; and (c) substantially no acetylation. The terms “substantially no acetylation” means that the occurrence of acetylation is less than about 0.8 per site.

In one aspect of the invention the polysaccharide of the invention comprises a backbone having a repeating unit and two different sidechains. Also disclosed is a polysaccharide with three different sidechains per repeating unit, an unusual property for a bacterium polysaccharide. The sidechains of the polysaccharide may be identical or different.

The present invention also sets forth a method for producing the polysaccharide. The method for example and not limitation, generally may include growing the Gluconacetobacter strain on a defined medium with sucrose and ethanol, harvesting the culture medium after sucrose consumption and centrifuging to remove cells. The extracellular polysaccharide is precipitated and recovered by centrifugation. However, other methods of producing a subject polysaccharide from its subject strain, as is known in the art, is also included herein.

The invention also includes an isolated and purified Gluconacetobacter strain having the capacity for the high production of the polysaccharide of the invention, while producing no or very little cellulose. An advantage of the present isolated and purified strain is that it is useful for various fields, and especially for the preparation of food or pet food products, or its incorporation in such foods. The Gluconacetobacter strain, for example, is Gluconacetobacter spp. having the Deposit number CNCM I-2281.

The present invention also provides food compositions and pet food compositions comprising the polysaccharide and/or strain of the invention. The polysaccharide and/or strain can be used as a texturizer, gelling agent, emulsifier, stabilizer, flavor enhancer intermediate, etc. For example and not limitation, a variety of foods such as salad dressings, vinegar, ice cream, fermented tomatoes, condiments such as ketchup and mustard and the like, may comprise the polysaccharide an/or strain. Although other food compositions may also include the polysaccharide and/or strain, as is known in the art.

The polysaccharide can also be used as an intermediate product for the isolation of rhamnose for increasing flavor levels in various food or pet food products.

A fermentation process is also provided for advantageously controlling the optimum biomass concentration and polysaccharide concentration by the Gluconacetobacter spp. strain of the invention.

### BRIEF DESCRIPTION OF THE DRAWINGS

FIG. 1 shows the structure of the polysaccharide gluconacetan produced by G. xylinus CNCM I-2281;

FIG. 2(a) shows the chemical structure of the bacterial polysaccharide xanthan. Xanthan contains partial O-acetylation at C6 on the (1→2) Man and terminal mannose residues;

FIG. 2(b) shows the chemical structure of the bacterial polysaccharide acetan. Acetan and CR/¼ is partially O-acetylated at the O-6 of the branching →4β-D-Glc-(1→residue and at the O-6 of the →2)-α-D-Man-(1→residue;

FIG. 2(c) shows the chemical structure of the bacterial polysaccharide CR¼ which is an acetan variant secreted by G. xylinus strain CR¼. CR¼ is partially O-acetylated at the O-6 of the branching →4)-β-D-Glc-(1→residue and at the O-6 of the →2)-α-D-Man-(1→residue;

FIG. 3 shows the structure of the gluconacetan polysaccharide produced by G. xylinus CNCM I-2281 with monosaccharide units identified by their residue letter code (A to I);

FIG. 4 shows a ID ¹H NMR spectra of the polysaccharide produced by G. xylinus CNCM I-2281 recorded in ²H₂O at 600 MHz and 67° C. Anomeric (H-1) resonances are identified by the corresponding residue letter code;

FIG. 5(a) shows the (C-6, H-6) region of the gluconacetan polysaccharide produced by G. xylinus CNCM I-2281. Spectra were recorded in ²H₂O at 600 MHz and 67° C.;

FIG. 5(b) shows the N-acetyl methyl region of the gluconacetan polysaccharide produced by G. xylinus CNCM I-2281. Spectra were recorded in ²H₂O at 600 MHz and 67° C.;

FIG. 5(c) shows (C-6, H-6) region of the acetan polysaccharide produced by the G. xylinus B42 strain. Spectra were recorded in ²H₂O at 600 MHz and 67° C.;

FIG. 5(d) shows the N-acetyl methyl region of the acetan polysaccharide produced by the G. xylinus B42 strain. Spectra were recorded in ²H₂O at 600 MHz and 67° C.;

FIG. 6 shows the viscosity of G. xylinus CNCM I-2281 gluconacetan polysaccharide solutions for different extracellular polysaccharide concentrations. Measurements performed at 25° C. with cone of 6 cm diameter and 1° angle.

FIG. 7 shows the viscosity of G. xylinus CNCM I-2281 polysaccharide solutions (bold line) and xanthan solutions (faint line) for different extracellular polysaccharide concentrations. Measurements were performed at 25° C. with cone of 6 cm diameter and 1° angle;

FIG. 8 shows the viscosity of G. xylinus CNCM I-2281 polysaccharide solution (bold line) and G. xylinus B42 polysaccharide (faint line) for different extracellular polysaccharide concentrations. Measurements performed at 25° C. with cone of 6 cm diameter and 1° angle;

FIG. 9 shows enzymatic hydrolysis of G. xylinus CNCM I-2281 polysaccharide by hesperinidase (Amano, JP) at 75° C., pH 3.8 for enzyme/substrate ratio of 0, 5 and 25%.

### DETAILED DESCRIPTION OF THE PREFERRED EMBODIMENTS

Within the following description, the following abbreviations have been used: CCDD, cross-correlated dipole-dipole NMR nuclear magnetic resonance experiment for determining glycosidic linkages; Galp, galactopyranose; GlcpA, glucuronic acid pyranose; Glcp, glucopyranose; HMBC, heteronuclear multiple-bond correlation; HPLC, high-performance liquid chromatography; PEP-HSQC, preservation of equivalent pathways in heteronuclear single-quantum coherence; NMR, nuclear magnetic resonance; NOESY, nuclear Overhauser effect spectroscopy; Rha, rhamnose; TOCSY, total correlation spectroscopy; TPPI, time proportional phase increments.

In accordance with one aspect of the invention, a novel bacterial polysaccharide (which has a xanthan-like structure) comprises a non-cellulosic backbone with 4-beta and 6-beta linkages, at least one sidechain per repeating unit and substantially no acetylation.

As used herein, the terms “substantially no acetylation” means that the acetylation is less than 0.8 per site, and preferably less than 0.5 per site. When the acetylation is greater than 0 per site, the possible sites for acetylation on the polysaccharide can be on the sidechain or on the backbone chain including the mannose on the sidechain or the glucose on the backbone chain. However, other sites for acetylation are also in accordance with the invention.

In one embodiment, the non-cellulosic backbone of the polysaccharide of the present invention has a repeating unit. In one embodiment, the repeating unit has the following structure: {[→4)-β-D-Glc-(1→4)-β-D-Glc-(1→]ₘ→6)-β-D-Glc -(1→4)-β-D-Glc-(1→}n, in which m is an integer between 1 and 10, but preferably equal to 2, and n is an integer between 100 and 1500, and preferably between 300 and 600, and which defines the number of repeating units.

In contrast to both acetan and xanthan, the backbone contains a β 1→6 linkage. In comparison to the linear cellulosic β 1→4 linkages, characteristic of acetan and xanthan, the β 1→6 linkage induces major conformational changes in the backbone. Indeed, the rheological properties of both acetan and xanthan have been hypothesized to be mainly guided by the cellulosic nature of the polysaccharide backbone responsible for the formation of helices in their tridimensional structures (Kirby, A. R. et al. (1995) Microscopy. Biophys. J. 68, 360-363). It is therefore likely that the properties measured for the polysaccharide of the present invention are significantly different, as will be described later, is a result of different backbone geometry.

The polysaccharide may comprise any number of sidechains per repeating unit. If more the polysaccharide has more than one sidechain per repeating unit, the composition of the sidechains can be identical or different. In one embodiment, the polysaccharide has at least two different sidechains per repeating unit, wherein one sidechain is identical to the acetan sidechain or mutants thereof and the other sidechain is different. In another embodiment, the polysaccharide has three sidechains per repeating unit (which is an unusual property for a bacterial polysaccharide) wherein two of the sidechains are equivalent to the usual acetan sidechain or mutants of the acetan sidechain and the other sidechain is different.

The packing of two different sidechains has a direct influence on the macroscopic rheological properties of the polysaccharide. Another important difference with acetan may be the absence of detectable acetylation.

One advantage is that the presence of different sidechains may increase molecular interactions. It is known that rheological properties are influenced by the length of the sidechains. It has been shown that decreasing the length of the sidechain enhances the solution viscosity. For example, it has been shown that variants of the acetan structure, produced by mutants of Gluconacetobacter obtained by chemical mutagenesis, are deficient in the sidechain sugar residues and the decreasing length of the sidechain enhances solution viscosity (Ridout, M. J. et al., (1994) Int. J. Biol. Macromol., 16, 6, 324-330). In one embodiment of the invention, the polysaccharide can have a structure deficient in the sidechain sugar residues thereby enhancing solution viscosity. Accordingly, the invention also relates to polysaccharide in which at least one sidechain is reduced from at least one residue. Accordingly, the invention also relates to polysaccharide in which at least one sidechain is reduced by at least one residue.

For purposes of illustration and not limitation, the sidechain(s) can be selected from a group consisting of:

αL-Rha(1→6)-βD-Glc-(1→6)-αD-Glc-(1→4)-βD-GlcA-(1→2)-αD-Man,

βD-Glc-(1→6)-αD-Glc-(1→4)-βD-GlcA-(1→2)-αD-Man,

αD-Glc-(1→4)-βD-GlcA-(1→2)-αD-Man,βD-GlcA-(1→2)-αD-Man,

αD-Man,αL-Rha(1→6)-βD-Glc-(1→6)-αD-Glc-(1→4)-βD-GlcA,

βD-Glc-(1→6)-αD-Glc-(1→4)-βD-GlcA, αD-Glc-(1→4)-βD-GlcA,

βD-GlcA, αL-Rha(1→6)-βD-Glc-(1→6)-αD-Glc, βD-Glc-(1→6)-αD-Glc,

αD-Glc, αL-Rha(1→6)-βD-Glc, αL-Rha, βD-Glc, and their derivatives.

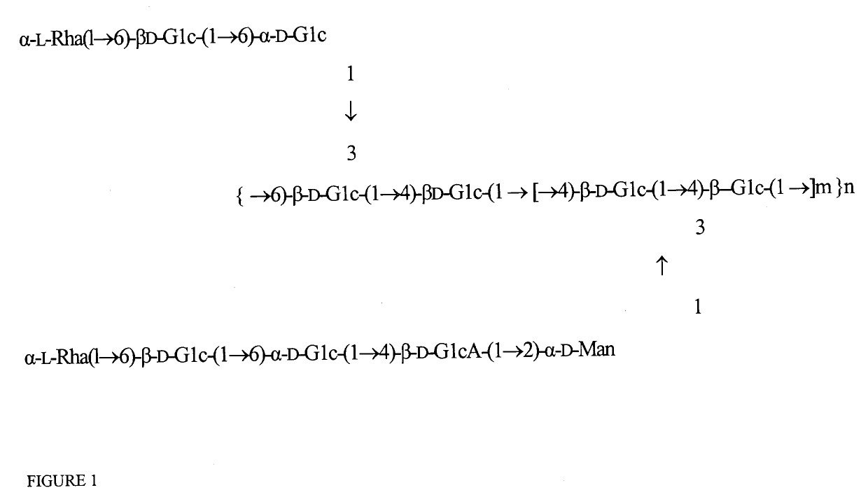

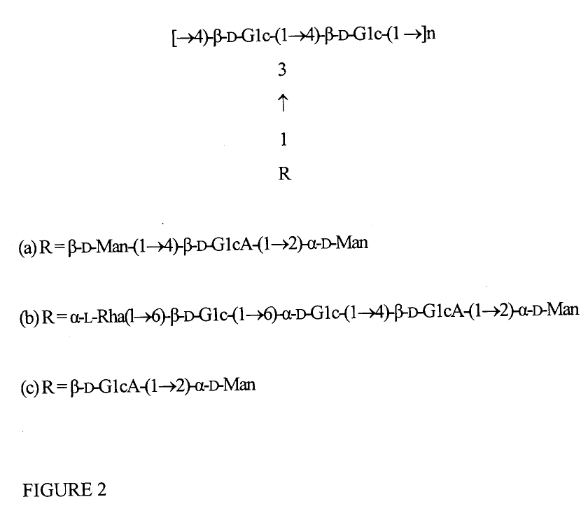

In a preferred embodiment, the polysaccharide is gluconacetan which has the primary structure presented in FIG. 1. The polysaccharide can be obtained by the strain Gluconacetobacter spp. having the deposit number CNCM I-2281.

Rheological properties of solutions of the polysaccharide of the invention were determined and compared to acetan and xanthan. As shown in Example 2 and discussed below, the polysaccharide in accordance with the invention exhibits different properties that can most likely be attributed to its structure, as well as the absence of acetylation and the non-cellulosic backbone.

The rheological behavior of the polysaccharide of the invention is slightly less shear-resistant at low concentration than xanthan, but more shear-resistant at higher shears. The likely consequence concerning the postulated mechanism of gellation is that the polysaccharide makes a different type of intermolecular interactions than acetan and xanthan. The formation of helical structures and helix-coil transition described for acetan must differ. Moreover, it is important to note that the viscosity was almost not affected by NaCl concentrations in the range 0.01-1 M. Considering the polysaccharide's structure together with its extremely high resistance to important stresses, it is likely that sidechain intertwining are the basis of resistance and gellifying properties.

In accordance with the invention the polysaccharide can be isolated by the following techniques. After growth of the strain on a defined medium (Peters, H. U. et al., (1989) Biotechnol. Bioeng, 34, 1393-1397) with sucrose and ethanol, culture medium was harvested after sucrose consumption and centrifuged (30 min, 5000 rpm, 4° C.) to remove cells. To precipitate soluble proteins, 250 g of trifluoroacetic acid was added per liter of supernatant, stirred for 1 h at 4° C. After centrifugation (30 min, 5000 rpm, 4° C.) pH was adjusted to neutrality with NaOH pellets and 2 volumes of ice cold ethanol were added. After stirring and cooling to 4° C., precipitated extracellular polysaccharide was recovered by centrifugation (30 min, 5000 rpm, 4° C.). Precipitate was dissolved in distilled water and dialyzed against demineralized water for two days (molecular weight cut-off 6000-8000 Da) and lyophilized. Other techniques of isolation of polysaccharides can also be used to isolate the polysaccharide of the invention from the strain, as is known in the art.

In addition to the polysaccharide of the invention, a purified isolate of Gluconacetobacter strain capable of producing the polysaccharide of the invention is provided in yet another aspect of the invention. Advantageously, the Gluconacetobacter strain has the capacity for a high production of polysaccharide and no or low production of cellulose. The polysaccharide produced by the strain of the invention comprises a non-cellulosic backbone with 4-beta and 6-beta linkages, at least one sidechain per repeating unit, and substantially no acetylation. As mentioned earlier, it has been surprisingly found that wild strains of G. xylinus have been shown to produce a bacterial polysaccharide, which has a non-cellulosic backbone with 4-beta and 6-beta linkages, the presence of at least one sidechain per repeating unit, and no or very little acetylation.

In a preferred embodiment, the Gluconacetobacter strain is a Gluconacetobacter spp. strain such as that deposited on Aug. 6, 1999 under the number CNCM I-2281 at the Institut Pasteur, 28 rue du Docteur Roux, F-75024 Paris cedex 15, FRANCE).

The Gluconacetobacter strain can be isolated from apple wine. The G. xylinus CNCM I-2281 strain produces under normal conditions, insoluble cellulose and a high-molecular-mass, highly soluble and texturizing heteropolysaccharide composed of glucose (Glc), rhamnose (Rha), mannose (Man) and glucuronic acid (GlcA) in the molar ratio of 7.3:1.4:1:1. Growth temperature conditions are between about 15 and 34° C., and preferably about 28° C. The pH is between 3.0 and 7.0, and preferably about 4.0, applied during a fermentation time of 3-4 days under vigorous agitation, which allows the production of the polysaccharide and no cellulose production (no cellulose was detected during fermentation).

The structure of the polysaccharide produced by CNCM I-2281 was determined by chemical analysis, mass spectrometry and nuclear magnetic resonance spectroscopy. The repeating unit of the polysaccharide produced by this strain is shown in FIG. 1.

Regarding the isolation of the stain according to the invention, the following media were described in the literature for selective and non-selective isolation of extracellular polysaccharide producing Gluconacetobacter strains: RAE (Sokollek, S. J. and Hammes, W. P. (1997) Appl. Microbiol. 20), SH (Hestrin, S., and Schramm, M., (1954) Biochemical journal 58: 345-352), and AJYE (Passmore, S. M., and Carr, J. G., (1974) J. Appl. Bacteriol. 38: 151-158) are best suited for isolation. These media were used to isolate strains of the genus Gluconacetobacter from running vinegar fermentations and from turbid vinegar. In static cultures the strains produced simultaneously high amounts of cellulose and polysaccharide. Studies with shaking cultures revealed that two of these isolates produced preferentially the polysaccharide according to the invention.

Under non-optimized fermentation conditions the culture achieved a total polysaccharide concentration >8 g/l in the broth supplemented with about 1% acetic acid or ethanol.

Reproducible growth curves and reproducible polysaccharide production were obtained for several experiments. Collected from an agitated liquid culture, isolated strain produces large amounts of polysaccharide on agar plates on a medium containing ethanol, yeast extract and saccharose. Selected strain was applied in pilot experiments for establishing optimum extracellular polysaccbaride production in food matrices.

The formation of polysaccharide depended on the composition of the nutrients. The production rate of polysaccharide was increased by addition of ethanol to the culture broth. A high glucose to yeast extract ratio stimulates extracellular polysaccharide biosynthesis and reduces cell growth.

Selection for increased polysaccharide producers was carried out by measuring extracellular polysaccharide in the culture medium by using the following non-limiting techniques:

i) centrifugation of the culture supernatant to remove bacterial cells,

ii) precipitation of extracellular polysaccharide by addition of ethanol or isopropyl alcohol,

iii) separation of the precipitate by filtration followed by vacuum-drying.

Preferred growth temperature of the Gluconacetobacter spp. strain according to the present invention is between 15 and 34° C., preferably at a growth temperature of 28° C., pH is between 3.0 and 7.0, preferably about 4.0, during a fermentation time of 3-4 days under vigorous agitation, which allows the production of extracellular polysaccharide and no cellulose production (no cellulose was detected during fermentation).

Advantageously, the high production of polysaccharide and no or very little production of cellulose by the Gluconacetobacter sp. strain allows its application in various fields, especially in the preparation of food or pet food products or its incorporation in food or pet food products. Unlike the non-food grade plant pathogen Xanthomaonas campestris, which produces xanthan, the Gluconacetobacter are not pathogenic and to date, no reports were found suggesting induction of any allergic responses. Thus, it is likely that there is less potential for allergic responses by consumers of food products, which incorporate or are prepared with the polysaccharides of the invention. Thus, in accordance with another aspect of the invention, is a food composition comprising the Gluconacetobacter sp. strain and/or the polysaccharide is provided.

The polysaccharide according to the present invention may be present in the food or pet food product in an amount of from about 0.01% to about 5%, and more preferably from 0.1% to 2%. The strain according to the invention may be used in the food or pet food product in an amount of at least 1.10⁶ cfu/g and more preferably from 10⁷ to 10⁸ cfu/g.

In a preferred embodiment, the polysaccharide is used for the preparation of self-thickened vinegar. However, the polysaccharide has various other applications such as for example and not limitation, the preparation of salad dressings, sauces, ketchup, mustard, and the like.

In other embodiments of the invention, the polysaccharide and/or strain is used for the preparation of fermented fruits or vegetables juices, such as fermented “self-textured” tomato juice that can be used for ketchup with a dietary fiber content and improved texture, milk drinks supplemented with extracellular polysaccharide rich, fermented foods and vegetables (papes/compotes, juices, food preparations for ice-cream, etc.), or as a polysaccharide-containing powder obtained by spray-drying, that find applications as a thickener in dehydrated products (such as soups and sauces).

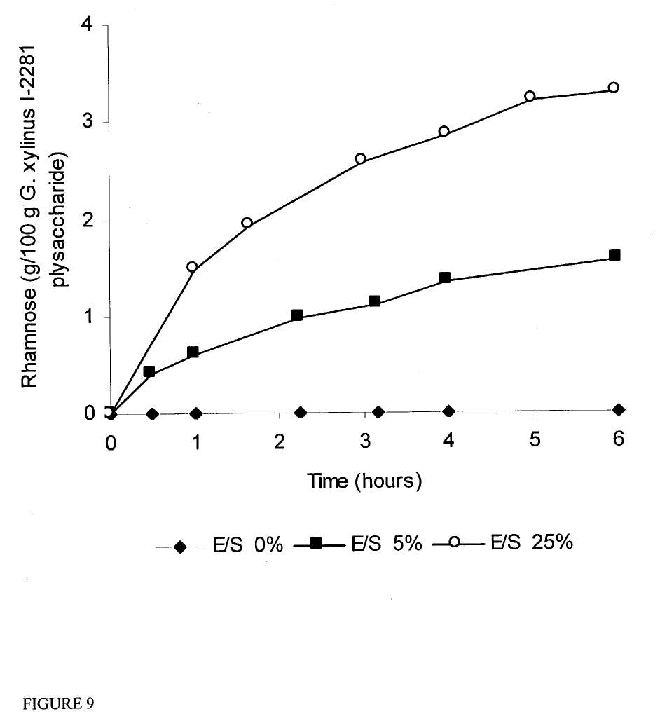

The polysaccharide is not only used as an ingredient in the food composition or preparation thereof. It can additionally be used in methods to increase flavor levels of food. For example, the polysaccharide can be used as an intermediate product for the isolation of rhamnose for the intention to increase flavor levels in food. At acidic pH and high temperatures, rhamnose is a precursor of furaneol and/or thiofuraneol. In order to release rhamnose, the isolated extracellular polysaccharide may be hydrolyzed by enzymatic reaction or by acidic hydrolysis in very mild conditions, preferably at a pH of about 2-4 and moderate heating of about 90° C., for example, in a medium containing amino-acids proteins and/or polypeptides, during a time sufficient for liberating at least one rhamnose residue per repeating unit which will generate furaneol and/or thiofuraneol. FIG. 9 shows the release of free rhamnose during enzymatic hydrolysis with hesperinidase (Amano, JP) at 75° C., pH 3.8 for enzyme/substrate ratio of 0, 5 and 25%. Accordingly, the polysaccharide can be used in methods for enhancing flavor levels in food by isolating rhamnose.

According to yet another aspect of the invention, a fermentation process for controlling optimum biomass concentration and polysaccharide concentration is provided. The process comprises the steps of maintaining and agitating the Gluconacetobacter spp. in a growth medium containing salts and a first substrate and a second substrate, S1 and S2 respectively, as carbon sources. The first substrate is a source of carbon for the production of biomass and the second substrate is a source of carbon for the production of polysaccharide.

Preferably, the first substrate (S1) is selected from the group consisting of ethanol, acetate, glycerol, succinic acid, citric acid and any organic acid containing 2 or 3 carbon atoms and intermediates of glycolysis and Tri Carboxylic Acid cycle (Krebs cycle), and any mixture thereof (referred as S1) and the second substrate (S2) is selected from the group consisting of glucose, fructose, saccharose, or any other sugar or combination thereof (referred as S2).

Advantageously, in order to obtain high biomass and polysaccharide concentrations, a high concentration of the first and second substrate(S1 and S2), can be present in the growth medium with an excess of dissolved oxygen.

Fermentation conditions controlling the biomass and the extracellular polysaccharide production by the bacterial strain include the following: the salts contained in the medium are those for example according to Peters et al. Underagitated conditions it was found that with this strain, as well as with other strains (e.g. DSM 2004, DSM 6315, DSM 46604, NRLL B42), most biomass formation occurred during consumption of S1, whereas extracellular polysaccharide was subsequently produced during consumption of sugar S2. Therefore, final biomass concentration was mainly determined by initial concentration of the first substrate, S1, and final extracellular polysaccharide concentration was mainly determined by the initial concentration of the second substrate, S2, and could reach values up to 50 g/L with no cellulose detected. High biomass and extracellular polysaccharide concentrations were obtained under excess of dissolved oxygen in the medium liquid. This was obtained by sufficient stirring and aeration rate of the media.

The following examples are given by way of illustration only and in no way should be construed as limiting the subject matter of the present application. All percentages are given by weight unless otherwise indicated. The examples are preceded by a brief description of the figures.

### EXAMPLES

### Example 1

Chemical Analysis of the Polysaccharide Produced by G. xylinus CNCM I-2281

Quantitative monosaccharide analyze of the polysaccharide produced by G. xylinus CNCM I-2281 was performed by HPLC after acid hydrolysis (2 N trifluoroacetic acid, 100° C., samples taken after 2, 4, 6 and 8 h).

For the methylation analysis, the polysaccharide produced by G. xylinus CNCM I-2281 was reduced by carbodiimide-activated reduction then was permethylated using methyliodide (Carpita, N. C., Shea, E. M., (1989) in: Analysis of carbohydrates by GLC and MS, Eds.: Bierman, C. J.; McGinnis, G. D., CRC Press, Boca Raton; Ciucanu, I. et al., Rapid Method for the Permethylation of Carbohydrates. Carbohydr. Res. 131, 209-217 (1984). The resulting partially methylated alditol acetates were analyzed by gas-liquid chromatography coupled to a mass spectrometer.

NMR Spectroscopy

Samples were dissolved in 99.96 atom % ²H₂O (Euriso-Top). All experiments were recorded on a three-channel Bruker DRX 600 MHz spectrometer equipped with an actively shielded pulsed-field z-gradient inverse triple-resonance probe. Chemical shifts are given in ppm by reference to the aanomeric signal of external [¹³C-1]-glucose (δ_{H-1} 5.15 for H-1 and δ_{C-1} 92.90 for C-1).

Phase-sensitive two-dimensional experiments were recorded using TPPI (Marion, D. et al., (1983) Biochem. Biophys. Res. Commun. 113, 967-974, TOCSY (Braunschweiler, L. et al., (1983) J. Magn. Reson. 53, 521-528) with mixing times between 15 ms and 90 ms, NOESY (Jeener, J. et al., (1979) J. Chem. Phys. 11, 4546-4553; Anil Kumar, Ernst, R. R. et al. (1980) Biochem. Biophys. Res. Commun. 95, 1-6) with mixing times between 50 ms and 250 ms, gradient sensitivity-enhanced ¹H-¹³C heteronuclear single-quantum coherence (PEP-HSQC) (Kay, L. E., et al. (1992) J. Am. Chem. Soc. 114, 10663-10665), and cross-correlated dipole-dipole (CCDD) experiment (Vincent, S. J. F. and Zwahlen, C. (2000) J. Am. Chem. Soc. 122, 8307-8308) for determining glycosidic linkages with constant-time durations of 10 to 40 ms.

A magnitude mode gradient-filtered ¹H-¹³C HMBC (Bax, A. et al. (1986) J. Am. Chem. Soc. 108, 2093-2094) was recorded with a J-evolution time of 50 ms. The following number of complex points were acquired (F₁, F₂): 512×4096 (TOCSY and NOESY), 256×2048 (HSQC) and 512×4096 (CCDD and HMBC), with averaging over 16 scans (TOCSY and NOESY), 128 scans (HSQC) or 256 scans (CCDD and HMBC). Spectral widths (ω₁, ω₂) of either 3600 Hz×3600 Hz (TOCSY and NOESY) or 3020 Hz×3600 Hz (HSQC, CCDD and HMBC) were used. A 90° shifted square sine-bell was used in all cases, with zero-filling once. All data were processed using Bruker XWINNMR 2.6 software.

Results

Monosaccharide analysis of the polysaccharide produced by G. xylinus CNCM I-2281. Acid hydrolysis with 2N trifluoroacetic acid at 100° C. showed that the amount of glucuronic acid, as determined from the amount of its main degradation product present, was roughly equivalent to the amount of mannose generated by the procedure (for one mole of mannose, 1.22 mole of glucuronic acid were found).

Methylation analysis of the gluconacetan polysaccharide produced by G. xylinus CNCM I-2281 (Table I) indicated the presence of glucose, rhamnose and mannose in the molar ratio of 5.5:1.4:1. Two different branching Glcp residues were found, whereas only terminal Rha was found, indicating a complicated branched repeating unit.

TABLE I
Chemical analysis data of the gluconacetan polysaccharide produced by
G. xylinus CNCM I-2281.

| | structureMSA | | | | | |
|---|---|---|---|---|---|---|
| | (NMR, m = 2) | | methylation | | | |
| Monosacc. | # | % | # | % | # | % |
| Rha-(1-> | 3 | 15.8 | 2.5 | 13.2 | 2.6 | 13.5 |
| ->2)-αMan-(1-> | 2 | 10.5 | 2.3 | 12.1 | 2.3 | 12.0 |
| ->4)-βGlcA-(1-> | 2 | 10.5 | 2.3 | 12.1 | 2.8 | 12.8 |
| all Glc^{a} | 12 | 63.2 | 11.9^{a} | 62.6^{a} | 11.7 | 61.7 |
| ->4)-βGlc-(1-> | 3 | 15.8 | — | — | 2.7 | 14.0 |
| ->6)-βGlc-(1-> | 3 | 15.8 | — | — | 2.9 | 15.2 |
| ->6)-βGlc-(1-> | 3 | 15.8 | — | — | 2.9 | 15.2 |
| ->3,4)-βGlc-(1-> | 2 | 10.5 | — | — | 3.0 | 16.1 |
| ->3,6)-βGlc-(1-> | 1 | 5.3 | — | — | 0.2 | 1.2 |
| Total | 19 | 100 | 19 | 100 | 19 | 100 |

^{a}The monosaccharide analysis only determines the total amount of any monosaccharide species, for example the total glucose content.

NMR Spectroscopy

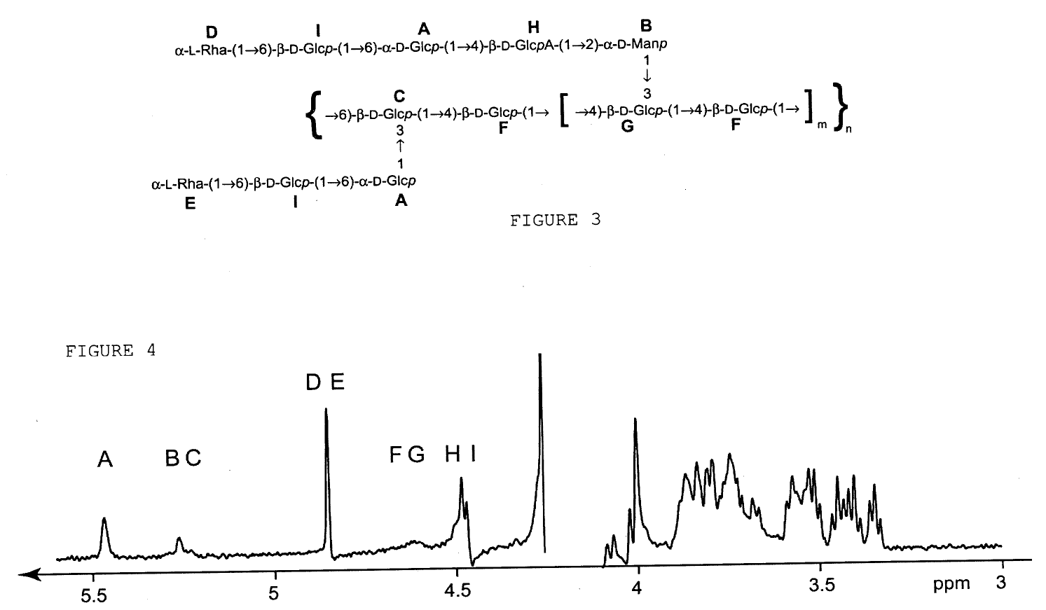

The 1D ¹H NMR spectra of the polysaccharide produced by G. xylinus CNCM I-2281 (FIG. 3) showed seven anomeric proton resonances with relative integrals 3:1.4:0.8:4.4:1.8:2.6:3.6. The linewidths vary significantly between different anomeric resonances, from 5 Hz to 30 Hz, indicating widely variable dynamical motions for various monosaccharide units.

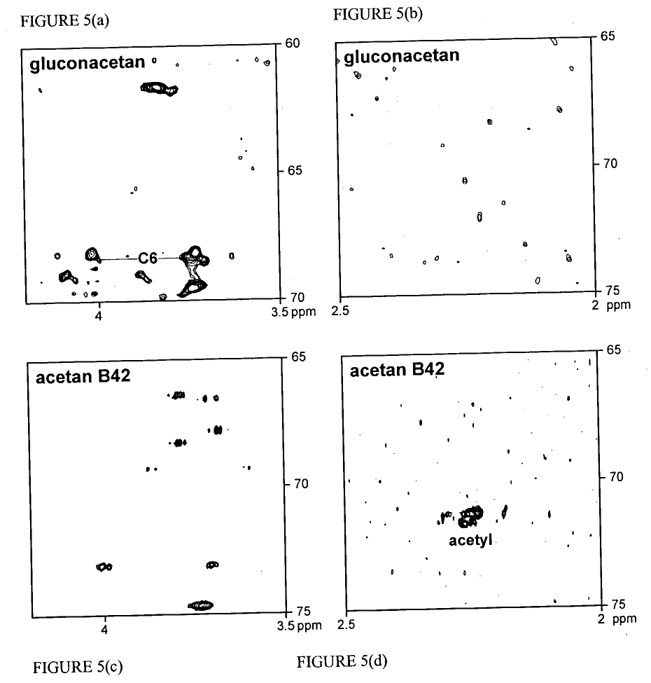

After observation of two-dimensional spectra, nine monosaccharide components within the repeating unit were identified and designated A to I following decreasing anomeric proton chemical shifts. Ring forms (hexose or pyranose) and anomeric configurations were deduced from H-1 chemical shifts and one-bond C-1, H-1 scalar couplings measured on the CCDD spectra. No N-acetyl methyl signal were observed around 2.08 ppm (FIG. 5(b)) indicating the absence of acetylation. This was confirmed by the shifts of carbon positions which were acetylated in the polysaccharide acetan and which were shifted to non-substituted position in the polysaccharide produced by G. xylitius CNCM I-2281 (cf. Table II). A set of standard polysaccharide NMR experiments were recorded on the polysaccharide produced by G. xylinus CNCM I-2281 at 67° C. The ¹H and ¹³C NMR assignments for the polysaccharide produced by G. xylinus CNCM I-2281 at 67° C. are collected in Table II.

TABLE II
¹H and ¹³C NMR chemical shifts of the polysaccharide produced by
G. xylinus CNCM I-2281 determined in ²H₂O at 67° C. The values are given in
ppm relative to external [¹³C-1]glucose (δ_{H-1(α)} 5.15 and δ_{C-1(α)} 92.90).^{a}

| | | H-1 | H-2 | H-3 | H-4 | H-5 | H-6a | H- | |
|---|---|---|---|---|---|---|---|---|---|
| | | C-1 | C-2 | C-3 | C-4 | C-5 | C-6 | 6b | CH₃ |
| A | →6)-α-D-Glcp-(1→ | 5.46 | 3.55 | 3.68 | 3.80 | 3.79 | 4.07 | 3.87 | |
| | | 99.8 | 72.6 | 73.8 | 71.4 | 72.1 | 69.0 | | |
| B | →2)-α-D-Manp-(1→ | 5.27 | 4.33 | 3.83 | 3.98 | 3.73 | 4.00 | 3.71 | |
| | | 100.8 | 79.6 | 70.7 | 73.8^{b} | 69.6 | 61.7^{c} | | |
| C | →3,6)-β-D-Glcp-(1→ | 5.23 | 3.36 | 4.38 | 3.53 | 3.64 | 3.99 | 3.73 | |
| | | 100.9 | 74.4 | 83.8 | 72.6 | 75.9 | 68.0 | | |
| D | α-L-Rhap-(1→ | 4.85 | 4.00 | 3.80 | 3.45 | 3.76 | | | 1.20^{d} |
| | | 101.7 | 71.1 | 71.4 | 73.3 | 69.6 | | | 17.7^{d} |
| E | α-L-Rhap-(1→ | 4.85 | 4.00 | 3.80 | 3.45 | 3.76 | | | 1.31^{d} |
| | | 101.7 | 71.1 | 71.4 | 73.3 | 69.6 | | | 17.7^{d} |
| F | →4)-β-D-Glcp-(1→ | 4.63 | 3.26 | 3.49 | 3.83 | 3.43 | 3.61 | 3.77 | |
| | | 97.2 | 75.1 | 76.8 | 80.6 | 76.9 | 61.8 | | |
| G | →3,4)-β-D-Glcp-(1→ | 4.58 | 3.41 | 3.81 | 3.87 | 3.66 | 4.02 | 3.83 | |
| | | 103.6 | 73.2 | 81.5 | 76.2 | 75.5 | 60.8^{c} | | |
| H | →4)-β-D-GlcpA-(1→ | 4.50 | 3.44 | 3.76 | 3.86 | 3.85 | | | |
| | | 103.3 | 73.8 | 76.8 | 81.2 | 76.6 | | | |
| I | →6)-β-D-Glcp-(1→ | 4.48 | 3.34 | 3.51 | 3.40 | 3.57 | 4.00 | 3.72 | |
| | | 103.7 | 74.1 | 76.8 | 70.9 | 75.9 | 68.1 | | |

^{a}Chemical shifts highlighted in bold typeface indicate positions at which a glycosidic link is identified based on differences to the corresponding reference chemical shifts.
^{b}Might indicate the presence of a substituent
^{c}In the acetan shifts, these positions were acetylated and shifted (B(C-6) = 64.6p and F(C-6) = 63.4p).
^{d}The peak intensity ratio in the PEP-HSQC was D(CH₃):E(CH₃) 1.75:1 indicating that the long “acetan-like” sidechain (D-I-A-H-B) is twice more present than the shorter sidechain (E-I-A).

The ¹H assignment of the polysaccharide produced by G. xylinus CNCM I-2281 started from the anomeric (H-1) resonances of each residue A to I in the TOCSY spectra recorded with increasing mixing times (15 to 90 ms).

Connectivities from H-1 to H-2,3,4 were traced for all nine residues, but due to overlap of pairs of anomeric proton resonances (D(H-1) and E(H-1) at 4.85 ppm, F(H-1) and G(H-1) at 4.60 ppm, and H(H-1) and I(H-1) at 4.49 ppm) and their linewidths on the order of the chemical shifts difference (LW˜15 Hz=0.02 ppm for □□˜0.02 ppm), a complete ¹H assignments were not obtained based on the TOCSY data alone.

Additional confirmations were obtained first from H-2,3,4,5 TOCSY traces, then from intra-monosaccharide intense NOESY cross-peaks and finally by assigning both the ¹H and the ¹³C resonances in the PEP-HSQC spectrum.

Resonances corresponding to aglyconic carbon atom involved in a glycosidic linkages were inferred from the ¹³C chemical shifts by identifying differences (>5 ppm) in comparison to monosaccharide methyl glycoside references (Bock, K. et al. (1982) Annu. Rep. NMR Spectrosc. 13, 1-57; Bock, K. et al. (1983) Adv. Carbohydr. Chem. Biochem. 41, 27-66; Bock, K. et al. (1983) Adv. Carbohydr. Chem. Biochem. 42, 193-225).

The sequence of the monosaccharide residues was deduced from the presence of cross-peaks in ¹H-¹³C CCDD, ¹H-¹³C HMBC spectra and NOESY spectra. Relevant cross-peaks are summarized in Table III.

TABLE III
CCDD, HMBC and NOESY information available for the determination
of interresidue correlations in the polysaccharide produced by G. xylinus CNCM I-
2281.^{a} Cross-peaks identities are indicated by (ω₁, ω₂) atoms identifications.^{b}

| CCDD | | | | |
|---|---|---|---|---|
| & | HMBC | | NOESY | Linkages |
| A(H-1) | H(C-4) | A(H-1) | H(H-2,3,4,5) | A-(1→4)-H |
| A(C-1) | H(H-4) | | | α-D-Glcp-(1→4)-β-D-GlcpA |
| A(H-1) | C(C-3) | A(H-1) | C(H-2,4) | A-(1→4)-C |
| A(C-1) | C(H-3) | C(H-3) | A(H-6b) | α-D-Glcp-(1→3)-β-D-Glcp |
| B(H-1) | G(C-3) | B(H-1) | G(H-1,2,3,4,5) | B-(1→3)-G |
| B(C-1) | G(H-3) | | | α-D-Manp-(1→3)-β-D-Glcp |
| | | C(H-1) | F(H-3) | C-(1→4)-F |
| | | C(H-3) | F(H-4) | β-D-Glcp-(1→4)-β-D-Glcp |
| D(H-1) | I(C-6) | D(H-1) | I(H-2,4,6a,6b) | D-(1→6)-I |
| D(C-1) | I(H-6a,6b) | | | α-L-Rha-(1→6)-β-D-Glcp |
| E(H-1) | I(C-6) | E(H-1) | I(H-2,4,6a,6b) | E-(1→6)-I |
| E(C-1) | I(H-6a,6b) | | | α-L-Rha-(1→6)-β-D-Glcp |
| F(H-1) | C(C-6) | F(H-1) | C(H-4,5,6a) | F-(1→6)-C |
| | | | | β-D-Glcp-(1→6)-β-D-Glcp |
| | | F(H-1) | G(H-4) | F-(1→4)-G |
| | | | | β-D-Glcp-(1→4)-β-D-Glcp |
| G(C-1) | F(H-4) | G(H-1) | F(H-4) | G-(1→4)-F |
| | | | | β-D-Glcp-(1→4)-β-D-Glcp |
| H(H-1) | B(C-2) | H(H-1) | B(H-2) | H-(1→2)-B |
| H(C-1) | B(H-2) | | | β-D-GlcpA-(1→2)-α-D-Manp |
| I(H-1) | A(C-6) | I(H-1) | A(H-3,6a,6b) | I-(1→6)-A |
| I(C-1) | A(H-6a) | | | β-D-Glcp-(1→6)-α-D-Glcp |

^{a}CCDD and HMBC provide the same information about glycosidic linkages (Vincent, S. J. F. and Zwahlen, C. (2000) J. Am. Chem. Soc. 122, 8307-8308), but using a different transfer mechanism: CCDD is based on cross-correlated dipole-dipole relaxation, while HMBC uses on the heteronuclear long-range scalar coupling across the glycosidic linkages.
^{b}ω₁ refers to the first (indirect) frequency dimension, while ω₂ refers to the second (direct) frequency dimension.

In all cases, glycosidic linkages were assigned relying simultaneously on the methylation analysis data, the ¹³C NMR assignments and the connectivities. The most critical connections between monosaccharide units were first the “cellulosic” (β-D-Glcp-(1→4)-β-D-Glcp) linkages C-(1→4)-F, F-(1→4)-G and G-(1→4)-F, then the “non-cellulosic” (β-D-Glcp-(1→6)-β-D-Glcp) backbone linkage F-(1→6)-C and finally the two linkages from residue A, first to the sidechain glucuronic acid H (α-D-Glcp-(1→4)-β-D-GlcpA) and, second, to the backbone branching C residue (α-D-Glcp-(1→3)-β-D-Glcp). The three cellulosic backbone β14 linkages were the hardest to identify as a direct result from the broad peaks associated with residues C, F and G. The non-cellulosic backbone β16 linkage was clearly demonstrated by the presence of CCDD, HMBC and NOESY cross-peaks between the anomeric proton of F and the atoms at or near the aglyconic position 6 of C (see Table III), in addition to the chemical shifts of residue C. The isolation of the carbon C(C-6) chemical shift leaves no doubt concerning this connection, even though these peaks are weak (see FIG. 5(a)). The two different linkages from residue A are demonstrated by several NOESYs and symmetry-related CCDD and HMBC cross-peaks (Table III).

In conclusion, based on chemical analysis and NMR spectroscopy, the structure of the repeating unit of the polysaccharide secreted by G. xylinus CNCM I-2281 can be formulated as represented in FIG. 3. The structure can accommodate a varying ratio of cellulosic to non-cellulosic backbone linkages, i.e. different value for m in the structure of FIG. 1. Based on the chemical analysis, the ratio of β16 to β14 bond should be small (Table I). According to rhamnose methyl NMR peak intensities, this ratio should be high. The best match was for m=2 where three sidechains per repeating unit are present, two identical to the acetan sidechain (D-I-A-H-B), and one smaller sidechain (E-I-A).

The polysaccharide repeating unit presents three sidechains. Two are five monosaccharide long and are identical in their composition to the acetan sidechain. In the polysaccharide produced by G. xylinus CNCM I-2281, they are attached to a backbone β-D-Glcp branching residue through α13 linkage. Contrarily to both acetan and the structurally-related xanthan polysaccharide, the polysaccharide produced by G. xylinus CNCM I-2281 additionally presents a different type of sidechain composed of three monosaccharide units also attached via a α1→3 linkage to a backbone β-D-Glcp branching residue. The identity of this additional sidechain is identical to the three terminal residues of the acetan sidechain. In the backbone, the β-D-Glcp were shown to be alternatively branched. Moreover, and in contrast to both acetan and xanthan, one backbone residue was found to have a β16 linkage. This induces major conformational changes in the backbone by comparison to the linear cellulosic β14 linkages. Indeed, the rheological properties of both acetan and xanthan have been hypothesized to be mainly guided by the cellulosic nature of the polysaccharide backbone responsible for the formation of helices in their tridimensional structures (Kirby, A. R et al. (1995) Microscopy. Biophys. J. 68, 360-363). It is therefore likely that the properties measured for the polysaccharide produced by G. xylinus CNCM I-2281 are significantly different as a result of different backbone geometry. In addition, the close packing of two different sidechains are shown to have a direct influence on the macroscopic rheological properties of the polysaccharide. Another important difference with acetan is the absence of detectable acetylation.

### Example 2

Rheology of the Polysaccharide

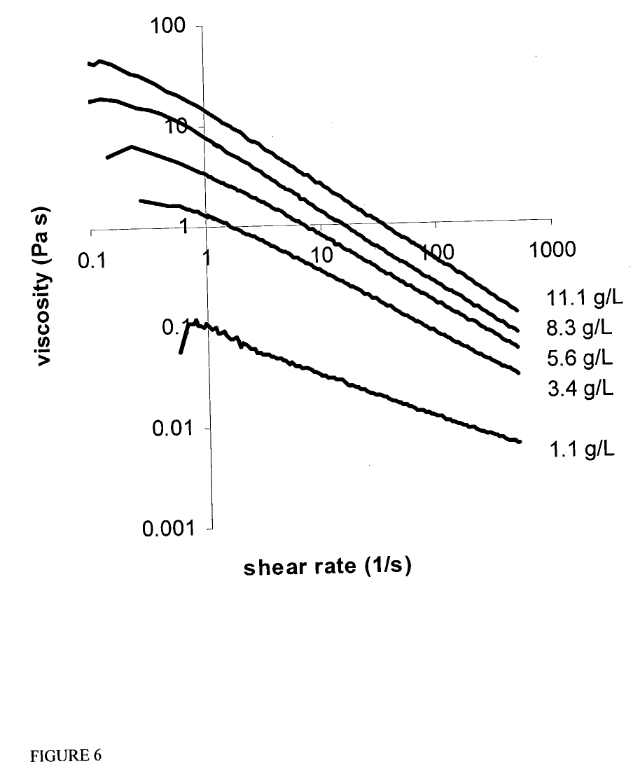

Purified extracellular polysaccharide samples were carefully dissolved in demineralized water. Xanthan (Rhodigel) was obtained from Meyhall (CH). Viscosity was measured at 25° C. with a viscometer (SCL2 Carri Med rheometer, TA Instruments, New Castle, USA) equipped with a cone of 6 cm diameter and 1° angle. Shear rate was varied from 0.5 to 500 l/s. FIG. 6 shows the profile of viscosity as a function of shear rate for the polysaccharide produced by G. xylinus CNCM I-2281.

The polysaccharide exhibits a shear thinning behavior: at low shear rate the viscosity is high and almost constant; at high shear rate viscosity decreases continuously and reversibly (thixotropy). The viscosity was almost not affected by NaCl concentrations in the range 0.01-1 M.

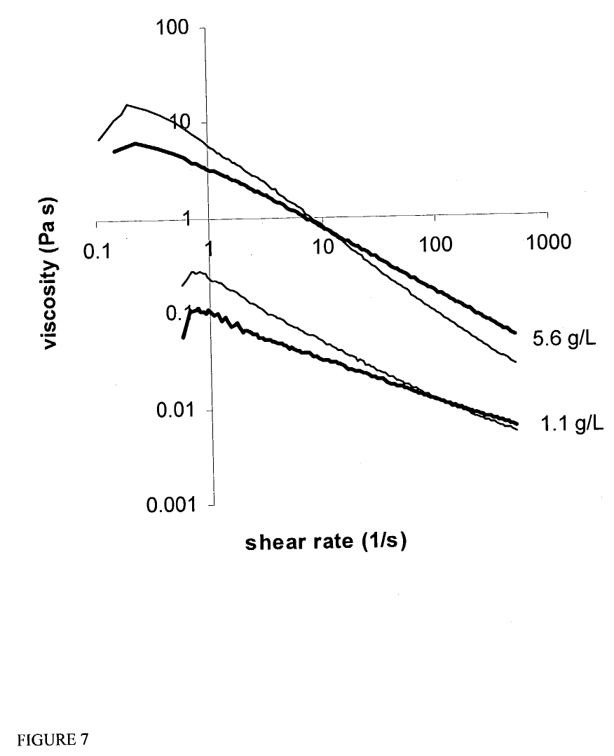

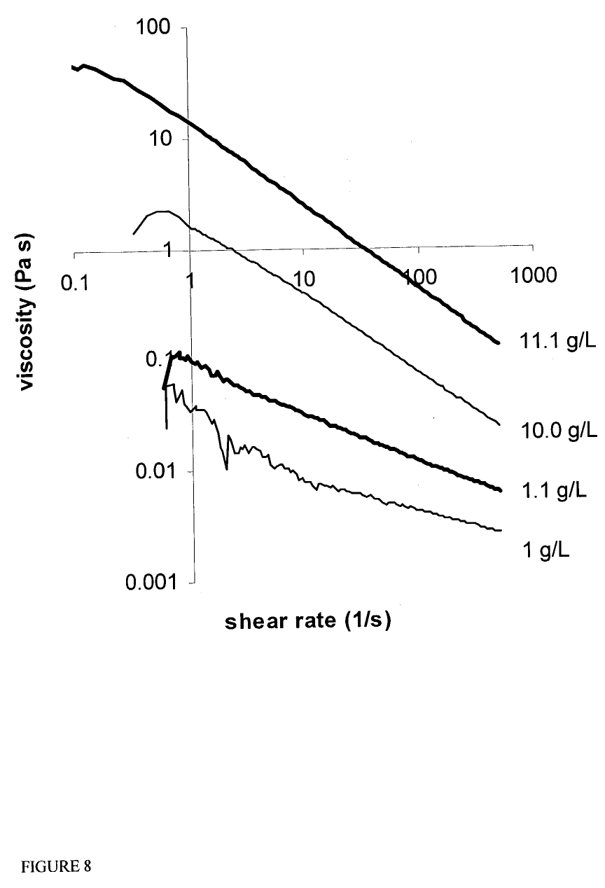

Compared to xanthan solutions, the viscosity of the new polysaccharide is higher at high shear rate (FIG. 7). For all shear rates tested, the viscosity of the new polysaccharide was significantly higher than the viscosity of the polysaccharide isolated from culture of G. xylinus B42 (FIG. 8).

### Example 3

Use of Extracellular Polysaccharide According to the Invention as Stabilizer for Particles or Emulsions in Food

Roughly 0.1% extracellular polysaccharide is used to suspend particles or droplets.

| | | |
|---|---|---|
| Food (e.g. salad) Dressing: | vinegar, | 94.9% |
| | solids, | 5% |
| | extracellular polysaccharide | 0.1% |
| | (as in example 1). | |

In a milk substitute 0.05% extracellular polysaccharide may be used to stabilize dispersions of dried whey or heat-processed soya protein in water.

### Example 4

Ice Cream Composition Using Extracellular Polysaccharide According the Invention

| | |
|---|---|
| Fat | 10% |
| Serum solids | 11.7% |
| Sucrose | 11.0% |
| Corn syrup solids | 4.8% |
| extracellular polysaccharide | 0.5% |
| (as in example 1) | |
| Water | 62.0% |

### Example 5

Preparation of Fermented Tomato Paste with the Strain of the Invention

100 g of commercially available tomato paste (type Pummaro, ex STAR, Milan, Italy) are aseptically transferred into a sterile 300 ml size glass bottle and inoculated with 0.5% of a washed cell suspension of the Gluconacetobacter spp. strain and to a starting cell concentration of 2×10⁶ cells per gram (determined as colony forming units). Before inoculation, the pH of the tomato 20 matrix is adjusted to a value of 4.0±0.1.

Subsequently, the inoculated tomato paste is fermented for 24 hours at 28° C. during which time samples are taken for carrying out analysis. After the fermentation is completed, the matrix is pasteurized for 30 minutes at 80° C. and cooled to room temperature.

The fermented tomato paste obtained by using the Gluconacetobacter spp. strain has excellent properties concerning serum development and excellent organoleptic properties.

### Example 6

Flavor Reaction

The isolated extracellular polysaccharide of example 1 is hydrolyzed by enzymatic reaction or by acidic hydrolysis in very mild conditions, i.e. pH about 2-4 and moderate heating of about 90° C., in a medium containing amino-acids proteins and/or polypeptides, during a time sufficient for at least liberating one rhamnose residue per repeating unit which will generate furaneol and/or thiofuraneol.

### Example 7

Pet Food Product

A mixture is prepared from 73% of poultry carcass, pig lungs and beef liver (ground), 16% of wheat flour, 7% of water, 2% of dyes, flavors, vitamins, and inorganic salts. This mixture is emulsified at 12° C. and extruded in the form of a pudding which is then cooked at a temperature of 90° C. It is cooled to 30° C. and cut in chunks. 45% of the chunks are mixed with 55% of a sauce prepared from 98% of water, 1% of dye and 1% of the extracellular polysaccharide gluconacetan. Tinplate cans are filled and sterilized at 125° C. for 40 min.

What is claimed is:

1. A polysaccharide having a structure comprising a non-cellulosic backbone having 4-beta and 6-beta linkages, at least one sidechain per repeating unit, and substantially no acetylation.

2. The polysaccharide of claim 1, wherein the non-cellulosic backbone has a repeating unit having the following structure {[→4)-β-D-Glc-(1→4)-β-D-Glc-(1→]ₘ→6)-β-D-Glc-(1→4)-β-D-Glc-(1→}n, wherein m is an integer between 1 and 10, and n is an integer between 100 and 1500.

3. The polysaccharide of claim 2, wherein m is 2.

4. The polysaccharide of claim 1, wherein a residue of the backbone has a β-16 linkage.

5. The polysaccharide of claim 1, wherein the structure has at least two sidechains per repeating unit.

6. The polysaccharide of claim 5, wherein the at least two sidechains are different.

7. The polysaccharide of claim 5, wherein at least one sidechain is identical to a sidechain of acetan or a mutant thereof.

8. The polysaccharide of claim 1, wherein the polysaccbaride has three sidechains per repeating unit.

9. The polysaccharide of claim 8, wherein two of the sidechains are identical to a sidechain of acetan or a mutant thereof.

10. The polysaccharide of claim 5, wherein at least one sidechain is attached to the backbone by a α-13 linkage.

11. The polysaccharide of claims 1, wherein at least one sidechain is selected from a group consisting of one of the following
αL-Rha(1→6)-βD-Glc-(1→6)-αD-Glc-(1→4)-βD-GlcA-(1→2)-αD-Man,
βD-Glc-(1→6)-αD-Glc-(1→4)-βD-GlcA-(1→2)-αD-Man, αD-Man,
αD-Glc-(1→4)-βD-GlcA-(1→2)-αD-Man, αD-Glc-(1→4)-βD-GlcA,
βD-GlcA-(1→2)-αD-Man, βD-Glc-(1→6)-αD-Glc-(1→4)-βD-GlcA,
αL-Rha(1→6)-βD-Glc-(1→6)-αD-Glc-(1→4)-βD-GlcA, βD-GlcA,
αL-Rha(1→6)-βD-Glc-(1→6)-αD-Glc, βD-Glc-(1→6)-αD-Glc, αD-Glc,
αL-Rha(1→6)-βD-Glc, αL-Rha, and their derivatives.

12. The polysaccharide of claim 1, wherein the acetylation is less than 0.8 per site.

13. The polysaccharide of claim 1, wherein the polysaccharide is gluconaecetan.

14. The polysaccharide of claim 13, having the primary structure of FIG. 1.

15. The polysaccharide of claim 13, wherein the gluconaecetan is obtained from the strain Gluconacetobacter spp. having the deposit number CNCM I-2281.

16. An isolated Gluconacetobacter spp. strain having the capacity to having the produce a polysaccharide, the polysaccharide comprising a non-cellulosic backbone with 4-beta and 6-beta linkages, and at least one sidechain per repeating unit.

17. The strain of claim 17, wherein the Gluconacetobacter spp. strain has the identifying characteristics of deposit number CNCM I-2281.

18. The strain according to one of claims 17, wherein the polysaccharide has the structure presented in FIG. 1.

19. A food composition comprising the polysaccharide of claim 1.

20. The food composition of claim 20, wherein the polysaccharide is present in an amount between about 0.01 to 5% of the food composition.

21. A food composition comprising the Gluconacetobacter strain of claim 17.

22. The food composition of claim 22, wherein the strain is present in an amount of at least about 1.10⁶ cfu/g.

23. A method of producing the polysaccharide of claim 1, comprising the following steps:
cultivating a gluconacetobacter strain micro-organism on a growth medium;
harvesting the culture medium to obtain a culture supernatant;
centrifuging the culture supernatant to remove cells; and
precipitating the polysaccharide to recover the polysaccharide.

25. The method of claim 24 wherein the cultivating step includes cultivating a Gluconacetobacter spp. strain having deposit number CNCM I-2281.

26. A fermentation process for controlling optimum biomass and polysaccharide concentrations, the process comprising the steps of
providing a Gluconacetobacter strain; and
agitating the Gluconacetobacter strain in a growth medium, wherein the growth medium comprises salts and a first and second substrate as carbon sources.

27. The process of claim 26, wherein the first substrate is the source of carbon for the production of biomass, and the second substrate is a source of carbon for the production of acetan.

28. The fermentation process of claim 27, wherein the first substrate is selected from a group consisting of ethanol, acetate, glycerol, succinic acid, citric acid, an organic acid; an intermediate of glycolysis; an intermediate of a Tri Carboxylic Acid cycle produced during Krebs cycle, and any mixture thereof.

29. The process of claim 27, wherein the second substrate is at least one sugar selected from a group consisting of: glucose, fructose, saccharose, and any combination thereof.

30. A method increasing flavor levels in a food composition comprising the step of:
hydrolyzing the polysaccharide of claim 1 for a time sufficient to liberate at least one rhamnose residue;
generating furaneol or thiofuraneoal from the liberated rhamnose residue; and
adding the liberated rhamnose or the generated furaneol to a food composition to increase the flavor level of the food.
